(19) United States
(12) Patent Application Publication
(10) Pub. No.: US 2006/0202459 A1
(43) Pub. Date: Sep. 14, 2006

(54) Vehicle occupant protection device

(75) Inventor: Norbert Friedrich, Rauhenebrach (DE)

Correspondence Address: LERNER GREENBERG STEMER LLP, P O BOX 2480, HOLLYWOOD, FL, 33022-2480, US

(73) Assignee: Leoni Bordnetz-Systeme GmbH & Co. KG

(21) Appl. No.: 11/429,798

(22) Filed: May 8, 2006

Related U.S. Application Data
(63) Continuation of application No. PCT/EP04/12613, filed on Nov. 8, 2004.

(30) Foreign Application Priority Data
Dec. 22, 2003 (DE) 103 60 342.5

(51) Int. Cl. B60R 21/04; B60J 7/00; B60L 1/00

(52) U.S. Cl. 280/751; 280/748; 296/187.05; 307/10.1

(57) ABSTRACT

An occupant protection device for reducing the risk of a head injury has a cable assembly element provided in the vicinity of the A-pillar and at the same time acts as an energy absorption element, thus forming a combined functional unit. This permits the risk of injury to be kept to a minimum and allows a simple assembly.

### CROSS-REFERENCE TO RELATED APPLICATIONS

This is a continuing application, under 35 U.S.C. §120, of copending international application No. PCT/EP2004/012613, filed Nov. 8, 2004, which designated the United States; this application also claims the priority, under 35 U.S.C. §119, of German patent application DE 103 60 342.5, filed Dec. 22, 2003; the prior applications are herewith incorporated by reference in their entirety.

### BACKGROUND OF THE INVENTION

### Field of the Invention

The invention relates to a vehicle occupant protection device, in particular a device for reducing the risk of head injuries in an accident.

In order to reduce the risk of head injuries, inter alia head airbags and side airbags are known which absorb the impact of the head when an accident occurs. However, the airbags only cover limited areas. One problem area which remains is what is referred to as the A pillar, that is to say the front most vehicle body pillar between the windshield and the front doors. In order to keep the risk of injury low here, energy-absorbing trim elements may be provided. These have, for example, ribs on their rear side facing away from the passenger compartment. However there is the risk here that in the event of an accident the trim elements are torn out of their attachments and move into the passenger compartment. In such a case it is also possible in particular for the ribs to break so that in some cases sharp edged parts may lead to injuries. As an alternative to the trim elements which are embodied as energy absorption elements it is also possible to provide energy absorption insertion parts which are inserted, for example, between the A pillar and the inner trim. This requires a comparatively high degree of mounting work. In addition, cables of an on-board power system are often disposed in the region of the A pillar and are laid in a separate mounting step, thus increasing the mounting work.

### SUMMARY OF THE INVENTION

It is accordingly an object of the invention to provide a vehicle occupant protection device which overcome the above-mentioned disadvantages of the prior art devices of this general type, which is easy to mount and in which in particular the risk of head injury is low.

With the foregoing and other objects in view there is provided, in accordance with the invention, a vehicle occupant protection device. The vehicle occupant protection device contains a vehicle bodywork pillar, pillar trim enclosing an intermediate space between the pillar trim and the vehicle body pillar, and a cable set element having a shaped body with cables embedded in the shaped body. The cable set element is disposed in the intermediate space and further functions as an energy absorption element for vehicle occupant protection and is formed as an integral, single-piece component.

There is provision here for the cable set element with the cables to be disposed in the intermediate space between a vehicle body pillar, in particular the A pillar, and a pillar trim, the cable element being simultaneously embodied as an energy absorption element for vehicle occupant protection.

There is provision for the cable set element which is laid in the region of the A pillar and the energy absorption element to be embodied as an integral, one-piece component. This measure keeps the mounting work low since only one element has to be mounted. When the cable set element is mounted, the energy absorption element is also mounted at the same time. The cable set element has in this respect a double function, specifically on the one hand it has an electrical function that is part of the on-board power system and, on the other hand, at the same time it has a protection function since it is configured to absorb energy in order to keep the risk of injury low in the case of an accident.

In order to be able to damp any impact of the head as well as possible, in one preferred development the cable set element has a foamed shaped body in which the cables are routed. The cable set element is therefore formed by comparatively soft and elastic material. The cables are, in particular, completely encapsulated by the foamed material in this context. As an alternative to this, it is only after the shaped body has been fabricated that the cable is connected to it. For this purpose, the shaped body preferably has an, in particular, groove-like recess into which the cable is held captively for example by pressing in or clipping in. Customary plastic materials are also used, for example, for cable sets which are encapsulated by foamed material. The energy absorbing properties, that is to say for example the hardness and elasticity of the shaped body, can be set over wide ranges in accordance with the desired requirements. Owing to the use of a foamed shaped body, in the event of an accident it is not possible for sharp edged parts to split off, move in to the passenger compartment and increase the risk of injury.

The cable set element, in particular the shaped body, is expediently adapted to the geometry of the pillar trim. The shaped body therefore bears against the pillar trim so that the protection function is ensured over the entire range of the internal pillar trim.

There is also preferably provision for the cable set element to at least largely fill the intermediate space. The cable set element, in particular the shaped body, is therefore adapted to the cross-sectional geometry of the intermediate space. On the one hand, the adaptation secures the cable set element in position. On the other hand, completely filling the intermediate space with the foamed shaped body provides a very high energy absorption capacity.

According to one expedient development, the cable set element is divided into an energy absorption zone and a cable routing zone. In this context, the cables are disposed in the cable routing zone while the energy absorption zone is in particular free of cables. This refinement is based on the idea that in the region in which the cables are disposed in the shaped body the latter usually has an increased degree of rigidity and hardness so that in this region there is a smaller energy absorption capacity. The energy absorption zone is therefore provided in the regions with the higher hazard potential. In this context, the cable routing zone is preferably formed on an edge region of the cable set element. Overall, an asymmetrical distribution and no identical distribution of the cables is implemented in the shaped body.

With respect to the simplest possible mounting, the cable set element has an integrally formed attachment element with which it is connected to the vehicle body pillar. The attachment element is, for example, a snap action hook or a latching element which is an integral component of the foamed shaped body.

According to one preferred development, the pillar trim and the cable set element form a common component. For this purpose, the pillar trim is applied in particular directly to the cable set element. For example there is provision for the pillar trim to be bonded as an initially separate element to the cable set element. Alternatively, the pillar trim can also be formed by directly forming a surface structure on the surface of the cable set element, for example by integral injection molding. Instead of the integral injection molding there is provision, according to a third alternative, for the shaped body of the cable set element to already have a surface structure which is suitable as the pillar trim. This is preferably brought about by using two different materials, in particular foams, for the shaped body, or by suitably configuring the surface of the shaping tool for the shaped body. The configuration as a common component simplifies mounting further so that the entire installation in the region of the A pillar, specifically the configuration of cables, the configuration of energy absorption elements and the configuration of the pillar inner trim can be carried out in a single work step by mounting the single integral component.

According to one expedient development, there is also provision for the cable set element with the shaped body which is embodied as an energy absorption element to be made to extend further from the A pillar in the direction of a further vehicle body pillar, for example the B pillar or C pillar. As a result of this measure, the protective element is made to extend further not only in the region of the A pillar but also at the side in the region of a roof strut which connects the vehicle pillar. This configuration is advantageous in particular for those vehicles in which there is no side airbag. In this context there is expediently provision for the shaped body also to extend at least partially into a further intermediate space between a vehicle body roof and a roof lining in order to ensure a sufficient protective function in the lateral hazardous region.

The shaped body preferably has a plurality of parts here. This simplifies manufacture. The parts, which are loosely connected to one another by the cables, also gives the cable set element an overall higher degree of flexibility which enables laying to be carried out easily. During mounting, the cables or a cable bundle are/is preferably inserted into the individual parts. For this purpose, the parts have, for example, recesses or are formed with slots in the longitudinal direction with an internal holding duct into which the cables are inserted after the slot has been bent open.

The object is also achieved according to the invention by a cable set element for such a device for vehicle occupant protection, having a shaped body in which cables are routed and which is embodied at the same time as an energy absorption element for vehicle occupant protection. Such a prefabricated cable set element can be easily mounted during fabrication at the motor vehicle manufacturer, the mounting of a single component permitting a plurality of functions to be implemented at the same time.

Other features which are considered as characteristic for the invention are set forth in the appended claims.

Although the invention is illustrated and described herein as embodied in a vehicle occupant protection device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1A is a diagrammatic, cross-sectional view through a region of an A pillar in a motor vehicle according to the invention;

FIG. 1B is a diagrammatic, sectional view of a cable set element which at the same time forms a pillar trim;

FIG. 2 is a diagrammatic, partial perspective view of a motor vehicle in a region between the A pillar and a B pillar; and

FIG. 3 is a diagrammatic, cross-sectional plan view in a region of a vehicle body strut between the A pillar and the B pillar.

### DESCRIPTION OF HE PREFERRED EMBODIMENTS

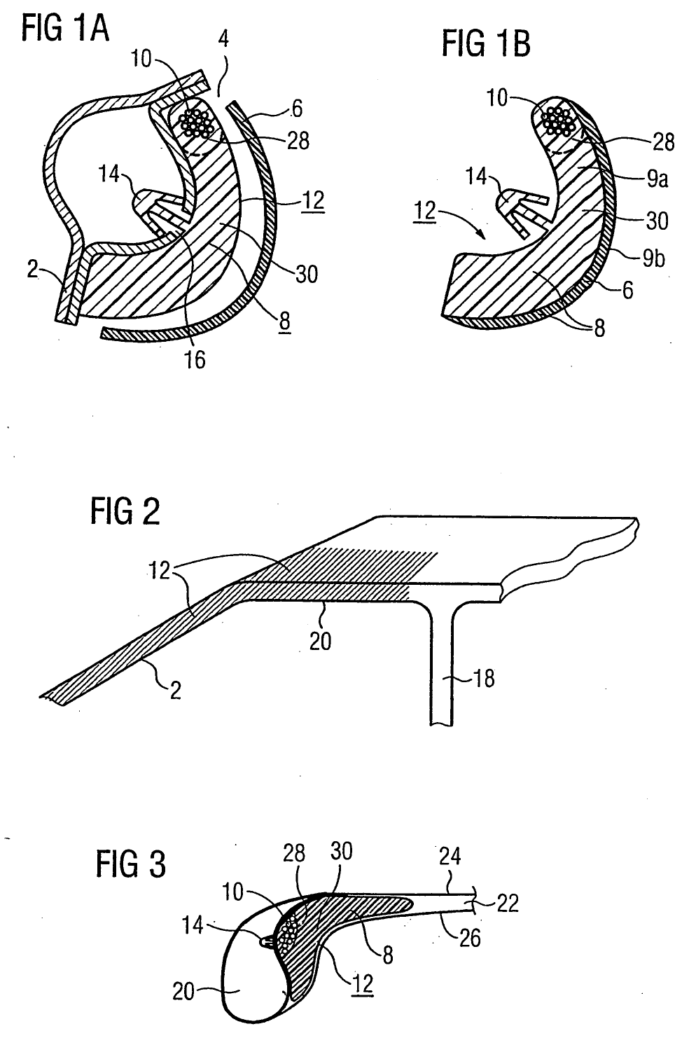

In all the figures of the drawing, sub-features and integral parts that correspond to one another bear the same reference symbol in each case. Referring now to the figures of the drawing in detail and first, particularly, to FIG. 1A thereof, there is shown an A pillar 2 for the passenger compartment of a motor vehicle which is covered by pillar trim 6, forming an intermediate space 4. A foamed shaped body 8 in which a plurality of cables 10 extend is disposed between the pillar trim 6 and the A pillar 2. The shaped body 8 with the cables 10 disposed therein forms a cable set element 12 as part of a motor vehicle on-board power system. Owing to the foamed shaped body 8, the cable set element 12 has a high energy absorption capacity and therefore also forms an energy absorption element at the same time. The shaped body 8 with the cables 10 which are encapsulated therein by foamed material therefore forms a combination component or a combined functional element which combines the functions of providing electrical lines on the one hand and absorbing energy on the other. The combined functional unit permits simple and rapid mounting while simultaneously providing multiple functionality. Since the shaped body 8 is composed of a foamed material, the cable set element 12 provides a high degree of reliability in the case of an accident since the shaped body 8 is virtually impossible to break owing to its high elasticity. In particular, it is not possible for sharply edged elements to penetrate the passenger compartment.

The cable set element 12 preferably has not only the cables 10 but also further electrical functional elements such as, for example, electronic components which are embedded in particular in the shaped body 8 and thus particularly well protected.

The cable set element 12 also has an attachment element 14 which is embodied as a snap-in hook and which is part of the shaped body 8. In order to attach the cable set element 12, the attachment element 14 is pushed through an attachment opening 16 in the A pillar 2. Owing to its elastic configuration, the side arms which are illustrated in FIG. 1A are pressed together and they then spring apart again in the interior of the A pillar 2. In order to attach the cable set element 12, it is of course also possible to provide alternative methods of attachment.

In order to ensure the protective function over as large an area as possible, the cable set element 12 is adapted to the contour of the pillar trim 6, that is to say the pillar trim 6 fits snugly against virtually the entirety of the cable set element 12. For the sake of better clarity, the pillar trim 6 has been illustrated spaced apart from the shaped body 8 in FIG. 1A.

As an alternative to configuring the pillar trim 6 as a separate element to be mounted, the pillar trim 6 may also be connected to the shaped body 8 before the mounting process. The cable set element 12 and the pillar trim 6 form a common component in this case. In a further simplification, the entire component in the exemplary embodiment in FIG. 1B is formed by virtue of the fact that the pillar trim 6 is part of the shaped body 8 itself. There is provision here, for the shaped body to be formed from two different foamed materials 9a, 9b. The foamed material 9b forms the visible surface and thus the pillar trim 6.

According to FIGS. 2 and 3 there is provision for the cable element 12 to be made to extend further from the A pillar in the direction of a B pillar 18. To be precise, the cable set element 12 is made to extend along a vehicle body strut 20 connecting the A pillar 2 to the B pillar 18. At the same time, the shaped body 8 also extends into a further intermediate space 22 between the outer skin of a vehicle body roof 24 and the inner trim of a roof lining 26.

The area in which the cable set element 12 is disposed is indicated in FIG. 2 by hatching. As an alternative to the area illustrated, the cable set element 12 may also be made to extend further in the B pillar or in the vehicle body strut 20.

According to the exemplary embodiment in FIG. 2, the shaped body 8 of the cable set element is embodied as a continuous, one-piece element. Alternatively, the shaped body 8 is composed of a plurality of non-illustrated parts. Thus, for example one part is provided for each of the A pillar 2, the B pillar 18, the vehicle body strut 20 and the intermediate space 22. In one embodiment variant the individual parts are not joined to one another so that the individual parts can be connected flexibly to one another by the cables 10.

As in the region of the A pillar 2 according to FIG. 1A, the cables 10 are also distributed in the shaped body 8 in a non-uniform way in the region of the vehicle body strut 20. This non-uniform distribution results in two functional zones in the shaped body 8, specifically on the one hand a cable routing zone 28 and on the other hand an energy absorption zone 30. The cable routing zone 28 has an energy absorption capacity which is lower compared to the energy absorption zone 30. The cable routing zone 28 is disposed here in an edge region of the shaped body 8. According to FIG. 3, the cable routing zone 28 is located in the rear region of the shaped body 8, which faces away from the passenger compartment and bears against the vehicle body strut 20. In the region of the cable routing zone 28, the cable set element 12 has a higher degree of rigidity and also a generally higher hardness than in the remaining area so that here the energy absorption capacity is lower than in the remaining area in which the cable set element 12 is composed exclusively of the foamed material of the shaped body 8. Disposing the cable routing zone 28 in the edge region or in the rear region ensures that the impact zone of the cable set element 12 has a high energy absorption capacity. Impact zone is understood here to be the region in which the impact of the vehicle occupant can be expected in the event of an accident.

The embodiment of the cable set element 12 simultaneously as an energy absorption element is preferably also implemented for other vehicle body parts such as, for example, doors.

Owing to the shaped body 8 which is embodied as a foamed body, the cable set element 12 also has a damping function at the same time. The cable set element 12 is expediently adapted in terms of the geometric configuration of its shaped body 8 to the predefined geometry of the vehicle body in such a way that at the same time effective thermal damping or sound damping is achieved.

I claim:

1. A vehicle occupant protection device, comprising:
a vehicle bodywork pillar;
a pillar trim enclosing an intermediate space between said pillar trim and said vehicle body pillar; and
a cable set element having a shaped body with cables embedded in said shaped body, said cable set element disposed in said intermediate space, said cable set element further functioning as an energy absorption element for vehicle occupant protection and as an integral, single-piece component.

2. The device according to claim 1, wherein said shaped body is a foamed shaped body in which said cables are routed.

3. The device according to claim 1, wherein said cable set element is adapted to a geometry of said pillar trim.

4. The device according to claim 1, wherein said cable set element at least largely fills said intermediate space.

5. The device according to claim 1, wherein said cable set element is divided into an energy absorption zone and a cable routing zone.

6. The device according to claim 5, wherein said cable routing zone is formed on an edge region of said cable set element.

7. The device according to claim 1, wherein said cable set element has an integrally formed attachment element connecting said cable set element to said vehicle bodywork pillar.

8. The device according to claim 1, wherein said pillar trim and said cable set element form a common component.

9. The device according to claim 1, wherein said cable set element is made to extend from said vehicle bodywork pillar in a direction of a further vehicle body pillar.

10. The device according to claim 9, wherein said shaped body is made to extend at least partially into a further intermediate space formed between a vehicle body roof and a roof lining.

11. The device according to claim 2, wherein said shaped body is divided into a plurality of individual parts.

12. The device according to claim 1, wherein said vehicle bodywork pillar is an A pillar.

13. A cable set element for a vehicle occupant protection device, the cable set element comprising:
a shaped body; and
a cable embedded in said shaped body, said shaped body simultaneously functioning as an energy absorption element for vehicle occupant protection.
